(19) United States
(12) Patent Application Publication
(10) Pub. No.: US 2015/0163265 A1
(43) Pub. Date: Jun. 11, 2015

(54) VIDEO WAKE-UP CALLS

(71) Applicant: Cox Communications, Inc., Atlanta, GA (US)

(72) Inventor: Ray Killick, Atlanta, GA (US)

(73) Assignee: Cox Communications, Inc., Atlanta, GA (US)

(21) Appl. No.: 14/097,761

(22) Filed: Dec. 5, 2013

(51) Int. Cl. H04L 29/06

(52) U.S. Cl. CPC H04L 65/60

(57) ABSTRACT

Embodiments disclosed herein relate to scheduled media transmissions which may be implemented in a hospitality setting as wake-up calls. A request for a scheduled media transmission may be received. The request includes a desired time for the scheduled media transmission and a requested content item. The scheduled media transmission is scheduled for a user at the desired time. At the user's desired time, a media device associated with the user is activated, and the user's requested content item is transmitted to the media device.

### TECHNICAL FIELD

Embodiments of this disclosure relate generally to wake-up calls.

### BACKGROUND

Hotels and other overnight lodging institutions typically provide their guests limited options to be woken up. For example, the hotel may provide a phone call at a time requested by a guest. These calls may be automated or manual. Alternatively, the guest may use an alarm clock located in the guest's room, or use his or her own alarm clock or mobile device to set an alarm. For various reasons, these solutions are undesirable.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts an illustrative data flow for scheduled media transmissions, in accordance with one or more embodiments of the disclosure.

FIG. 2A illustrates an example scheduled media transmission system, in accordance with one or more embodiments of the disclosure.

FIG. 2B illustrates a further example scheduled media transmission system, in accordance with one or more embodiments of the disclosure.

FIG. 3 depicts a flow diagram of a method for scheduling and transmitting a scheduled media transmission, in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

Embodiments of the disclosure now will be described more fully hereinafter with reference to the accompanying drawings, in which embodiments of the disclosure are shown. This disclosure may, however, be embodied in many different forms and should not be construed as limited to the embodiments set forth herein; rather these embodiments are provided so that this disclosure will be thorough and complete, and will fully convey the scope of the disclosure to those skilled in the art. Like numbers refer to like elements throughout.

Certain embodiments herein may be directed to providing scheduled media transmission. A hotel may offer its guests the ability to be woken up by various media content, such as music, video, television content, or hotel-specific content. In addition, the volume of a scheduled video or other media transmission may be increased gradually to make a user's wake-up experience more pleasant. Hotels may control the media content choices, and may incorporate hotel-specific messages and advertising in the media content. While various embodiments and features of the present disclosure are described in the context of a hotel, it will be appreciated that the solutions described herein may equally be applied to a residential or other commercial setting.

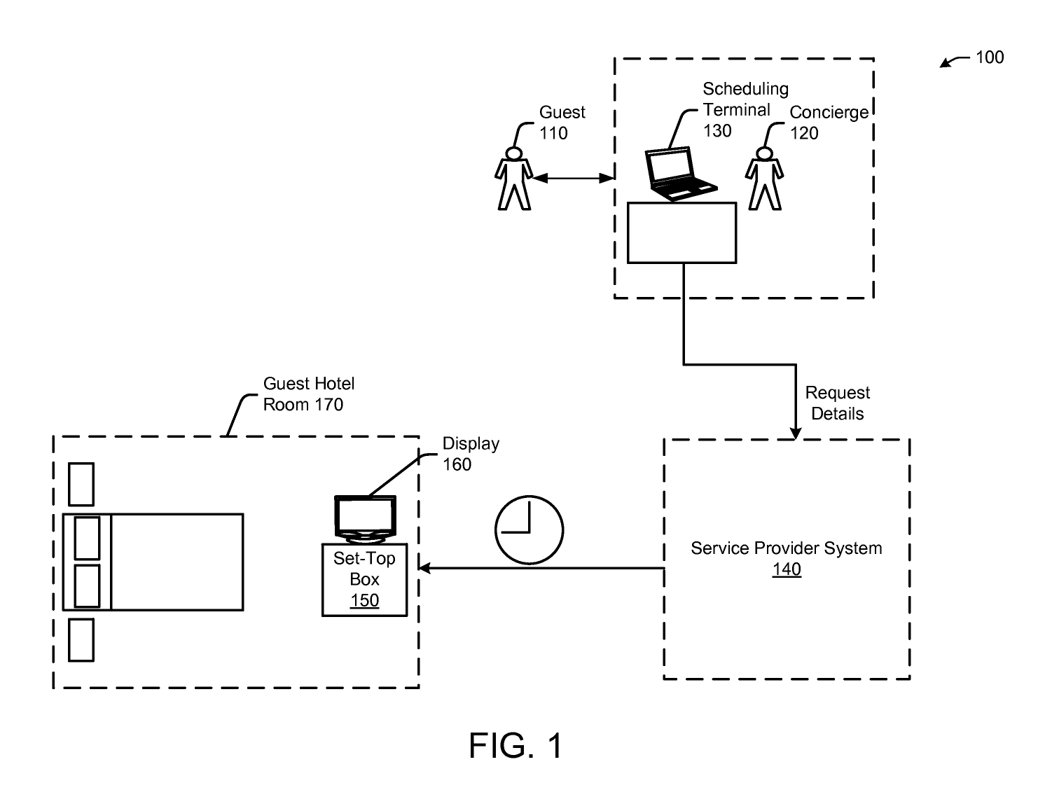

FIG. 1 depicts an illustrative data flow for providing scheduled media transmission, in accordance with one or more embodiments of the disclosure. In the data flow of FIG. 1, a user 110, such as a guest of a hotel, may speak with a representative of the hotel, such as a desk clerk 120 or concierge, to schedule a media transmission. The desk clerk 120 may use a scheduling terminal 130 to schedule the guest's requested media transmission at a particular time the guest desires. The guest's request may include a requested content item identified by the guest, such as a particular music video or television show. The scheduling terminal 130 may communicate with a service provider system 140 to schedule the request, and include the details of the request, such as the time and content item. At the scheduled time, the service provider system 140 may communicate with a media device, such as a set top box 150 (STB) or other media device, in the guest's hotel room 170. The service provider system 140 may activate the set top box 150, and transmit the guest's requested content item to the set top box. The set top box 150 may be coupled to or integrated with a display 160, such as a television or monitor and/or a video recording device, such as a camera.

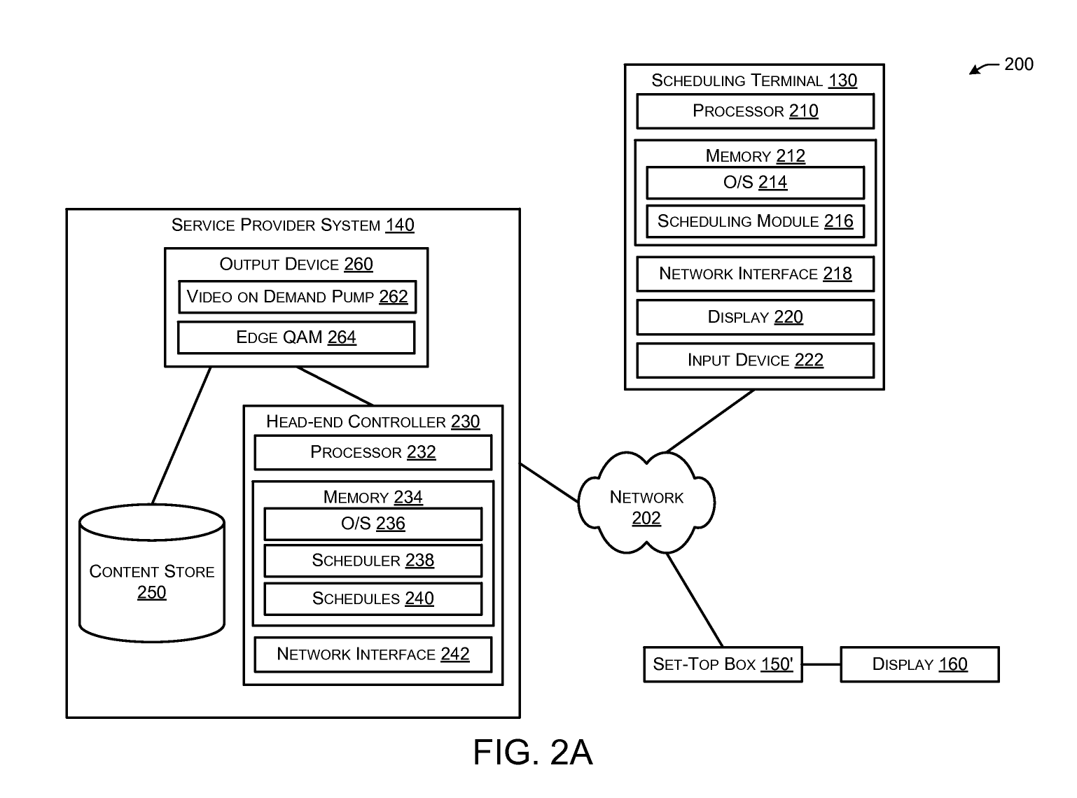

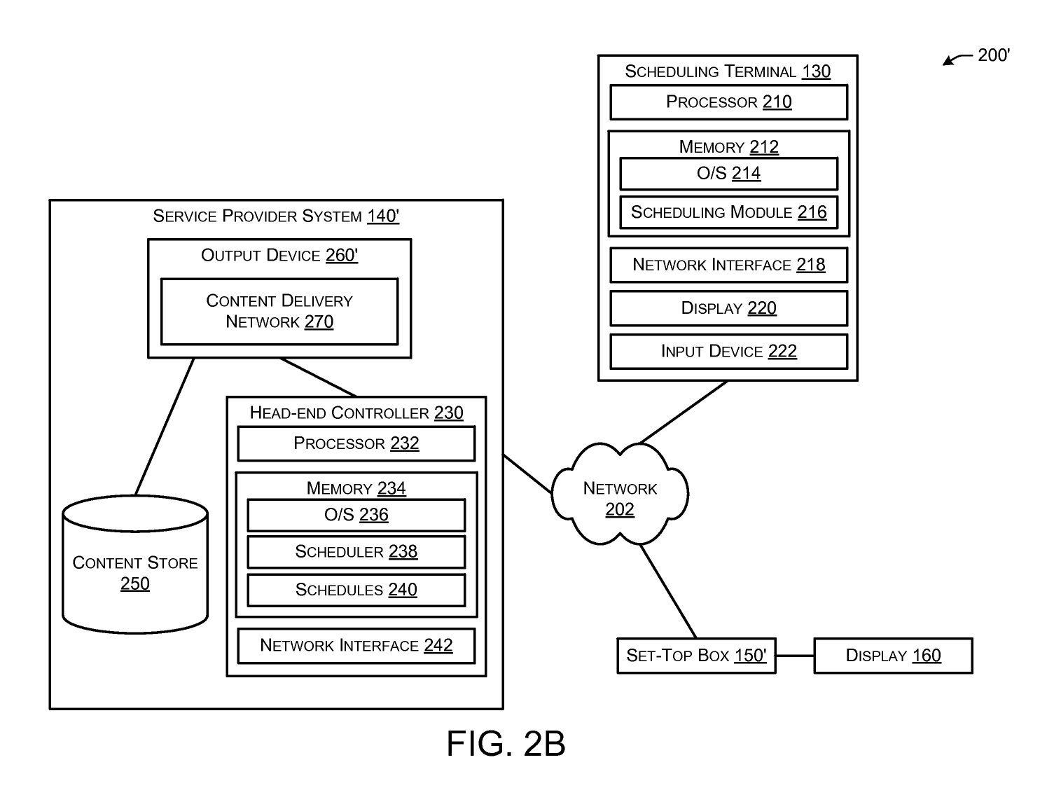

FIG. 2A illustrates an example scheduled media transmission system 200 illustrating in more detail the various components described in FIG. 1. The system 200 illustrated in FIG. 2A may be used in a traditional cable television infrastructure, for example a radio frequency coaxial network or hybrid fiber-coaxial network. As described with respect to FIG. 1, system 200 includes a scheduling terminal 130, service provider system 140, and set top box 150. Scheduling terminal 130, service provider system 140, and set top box 150 may be in communication with each other via network 202.

Scheduling terminal 130 may be associated with a hotel or other hospitality institution wishing to provide scheduled media transmission to its customers. A hospitality institution may have multiple scheduling terminals 130. Scheduling terminal 130 may include one or more processors 210, a memory 212 storing an operating system 214 and scheduling module 216, network interface 218, display 220, and input device 222. In one embodiment, scheduling terminal 130 may be a desktop computer, laptop computer, tablet computer, smartphone, or other such device.

The computer processors 210 may comprise one or more cores and may be configured to access and execute (at least in part) computer-readable instructions stored in the memory 212. The one or more computer processors 210 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The scheduling terminal 130 may also include a chipset (not shown) for controlling communications between the one or more processors 210 and one or more of the other components of the scheduling terminal 130. The one or more processors 210 may also include one or more application-specific integrated circuits (ASICs) or application-specific standard products (ASSPs) for handling specific data processing functions or tasks.

The memory 212 may comprise one or more computer-readable storage media (CRSM). In some embodiments, the memory 212 may include non-transitory media such as random access memory (RAM), flash RAM, magnetic media, optical media (e.g. CD-ROM, DVD-ROM, BD-ROM), read-only memory (“ROM”), erasable programmable ROM (“EPROM”), electrically EPROM (“EEPROM”), solid-state media, and so forth. The memory 212 may be volatile (in that information is retained while providing power) or non-volatile (in that information is retained without providing power). Additional embodiments may also be provided as a computer program product including a non-transitory machine-readable signal (in compressed or uncompressed form). Examples of machine-readable signals include, but are not limited to, signals carried by the Internet or other networks. For example, distribution of software via the Internet may include a non-transitory machine-readable signal. Additionally, the memory 212 may store an operating system 214 that includes a plurality of computer-executable instructions that may be implemented by the computer processor 210 to perform a variety of tasks to operate the interface(s) and any other hardware installed on the scheduling terminal 130. The memory 212 may also store content that may be displayed by the scheduling terminal 130 or transferred to other devices (for example, headphones) to be displayed or played by the other devices. The memory 212 may also store content received from the other devices. The content from the other devices may be displayed, played, or used by the scheduling terminal 130 to perform any necessary tasks or operations that may be implemented by the computer processor 210 or other components in the scheduling terminal 130.

The memory 212 may also store a scheduling module 216 that includes a plurality of computer-executable instructions that may be executed by the processor 210 to perform a variety of tasks, as will be further explained below.

The network interface 218 may also comprise one or more communication interfaces or network interface devices to provide for the transfer of data between the scheduling terminal 130 and another device (e.g., network server, service provider system, hotel reservation system) via a network, such as network 202. The communication interfaces may include, but are not limited to: personal area networks (PANs), wired local area networks (LANs), wireless local area networks (WLANs), wireless wide area networks (WWANs), and so forth. The scheduling terminal 130 may be coupled to the network 202 via a wired or wireless connection.

Display 220 may include, but is not limited to, a liquid crystal display, a light-emitting diode display, or a cathode-ray tube display. Other such displays are possible as well. The display may be used to show content to a user in the form of text, images, or video. In certain instances, the display may also operate as a touch screen display that may enable the user to initiate commands or operations by touching the screen using certain finger or hand gestures.

Scheduling terminal 130 also includes one or more input devices 222. An input device 222 may include a touch screen input device coupled with or combined with display 220 that enables the user to initiate commands by touching the screen. Input devices 222 may also include a keyboard, numeric pad, mouse, trackball, one or more electromechanical buttons, a camera which detects gestures, or another input device.

In operation, a hotel representative may use scheduling terminal 130 to schedule a media transmission in response to a request from a guest. For example, a scheduling module 216 may prompt the hotel representative to use an input device 222 to enter in the guest's room number, a time for the scheduled media transmission (that is, when the media should be played in the guest's room), and the guest's desired content. In one embodiment, scheduling module 216 may provide a listing of content items from which a guest may select a content item for a scheduled media transmission. In one embodiment, scheduling module 216 may require the guest to provide some form of authentication to the hotel representative or scheduling terminal 130, to ensure that the guest is scheduling a media transmission for his or her own room, and not the room of another guest. For example, the guest may be required to swipe his hotel key card, credit card, or provide other authenticating information, to schedule a media transmission. The scheduling terminal 130 may communicate with other systems in a hotel to verify the guest's identity and room number, such as the hotel's telephony system or reservation system.

Service provider system 140 may include headend controller 230, content store 250, and output device 260. Headend controller 230 may include one or more processors 232, a memory 234 storing an operating system 236, scheduler 238, and schedules 240, and network interface 242. In one embodiment, headend controller 230 may be a desktop computer, server device, a collection of server devices (e.g., a server cloud), or any other similar device.

Processors 232 and memory 234 may be substantially similar to processors 210 and memory 212 described above. For example, as described above, memory 234 may store an operating system 236 that includes a plurality of computer-executable instructions that may be implemented by the computer processor 232 to perform a variety of tasks to operate the interface(s) and any other hardware installed on the scheduling terminal 140.

The memory 234 may also store a scheduler 238 which may include a plurality of computer-executable instructions that may be executed by the processor 232 to schedule one or more media transmissions, as described herein. Scheduler 238 may store schedules 240 and other information related to such scheduled media transmissions in memory 234.

The network interface 242 may also be substantially similar to network interface 218, and may comprise one or more communication interfaces or network interface devices to provide for the transfer of data between the service provider system 140 and another device (e.g., scheduling terminal 130) via a network, such as network 202.

Output device 260, in the example of FIG. 2A, may include a video-on-demand pump (VOD pump) 262 and an edge quadrature amplitude modulation (QAM) device 264. Edge QAM 264 may communicate with one or more set top boxes 150 to transmit video or other content provided by the VOD pump 262 or other sources.

In operation, scheduler 238 may receive, for example, from scheduling terminal 130, a request for a scheduled media transmission. Scheduler 238 may receive the requesting guest's room number, the requested time for the media transmission, and the guest's desired content. As described above, scheduler 238 may store this information in memory 234 as a schedule 240.

At a time specified in a request for a scheduled media transmission, or a few seconds before the requested time, headend controller 230 may transmit a message or otherwise initiate communication with a guest's set top box 150. The message may cause the set top box 150 to turn on or activate. Further, the same message or a subsequent instructional message may include, in one embodiment, an identification of the content item requested by the guest. The instructional message may also instruct the set top box 150 to activate or turn on a display 160 connected to the set top box 150, such as a television. In response, the set top box 150 may initiate a communication session with headend controller 230. To request content playback

In response to establishment of the communication session, headend controller 230 may initiate a content stream with VOD pump 262. VOD pump 262 may search for the guest's requested content. If VOD pump 262 cannot locate the guest's requested content, for example, if the requested content is not in a cache of VOD pump 262, VOD pump 262 may retrieve the requested content from content store 250. VOD pump 262 may then, in conjunction with edge QAM 264, transmit the content via edge QAM 264 to the guest's set top box 150.

Set top box 150 may include any suitable device configured to receive and process one or more broadband data signals output by the service provider system. Set top box 150 may also accept input signals and commands from devices such as remote controls. Further, any number of suitable networks 202 may facilitate communications between the various components of the system 200.

FIG. 2B illustrates a second example scheduled media transmission system 200′ illustrating in more detail an alternative arrangement of the various components described in FIG. 1. The system 200′ illustrated in FIG. 2B may be used in an internet protocol (IP) based infrastructure or an adaptive bit rate infrastructure. As described with respect to FIGS. 1 and 2A, system 200′ includes a scheduling terminal 130, service provider system 140′, and set top box 150′. Scheduling terminal 130, service provider system 140′, and set top box 150′ may be in communication with each other via network 202. Scheduling terminal 130 and set top box 150′ of FIG. 2B may be identical or substantially similar to scheduling terminal 130 and set top box 150′ of FIG. 2A described above.

Service provider system 140′ may include headend controller 230, content store 250, and output device 260′. Headend controller 230 and content store 250 in FIG. 2B may also be identical or substantially similar to headend controller 230 and content store 250 of FIG. 2A described above. In the example infrastructure of FIG. 2B, output device 260′ may include one or more content delivery networks 270. Such a content delivery network 270 may include one or more distributed server computers in various locations, used to efficiently distribute data including video and other multimedia content.

In operation, at a time specified in a request for a scheduled media transmission, or a few seconds before the requested time, headend controller 230 may transmit a message or otherwise initiate communication with the guest's set top box 150. As described above, the message may include, in one embodiment, an identification of the content item requested by the guest. Further, in one embodiment, the headend controller 230 may transmit a playlist or other information using a universal resource locator (URL) to the set top box 150.

In response to receiving the playlist, set top box 150 may request the content items identified on the playlist from CDN 270. CDN 270 may search for the content on the playlist, and transmit the content to the set top box 150. Alternatively, if CDN 270 does not have the requested content in a cache, CDN 270 may retrieve the requested content from content store 250. CDN 270 may then transmit the requested content to set top box 150. In one embodiment, content store 250 may directly transmit the requested content item to set top box 150.

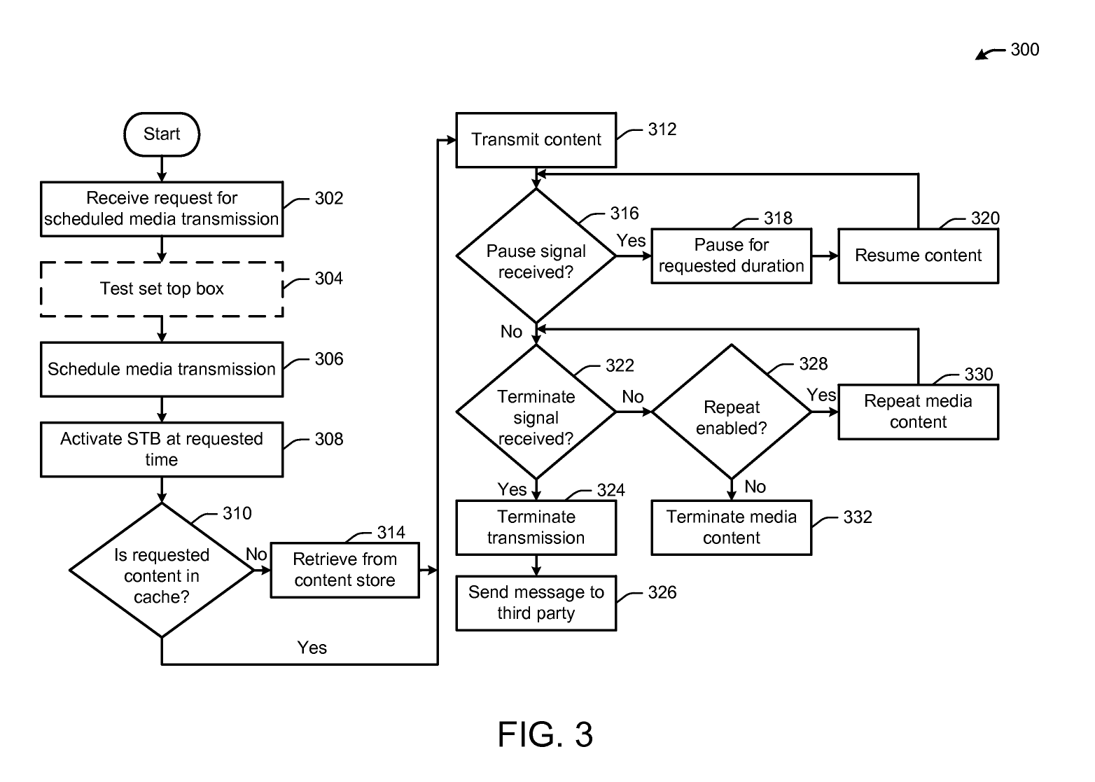

FIG. 3 illustrates a flow diagram of a method 300 for managing, scheduling and transmitting a scheduled media transmission, according to one or more embodiments disclosed herein. Method 300 may be implemented, in one embodiment, by a headend controller 230 of a service provider system 140.

At block 302, a request for a scheduled media transmission is received. The request may be received from, for example, a scheduling terminal 130 operated by a hotel representative. In one embodiment, the request may also be received from a residential user through use of a mobile application or a web-based application. The request may include a desired time for the scheduled media transmission and a requested content item. Further, the request may include an identification of a guest room number, a set top box identifier, or identifying information for any other device for receiving the scheduled media transmission. The request may also include the time and/or date of the request. In one embodiment, the request further includes a desired language for the scheduled media transmission. The request may also include, in one embodiment, payment information. For example, if the guest's requested content item is a pay-per-view (PPV) video, the guest may be asked to provide payment information for the video.

At optional block 304, the set top box or other receiving device may be tested to ensure that it can receive the scheduled media transmission. For example, headend controller 230 may transmit a signal to a set top box 150, and request a response from the set top box 150 to ensure that scheduled media transmissions can properly take place.

At block 306, the media transmission is scheduled for the requested time. For example, headend controller 230 may store or record in a database a scheduled media transmission object with an identification of the requested content, the time of the scheduled media transmission, the guest room or other receiving device, time and date of the request, the language, and/or any other information needed for the scheduled media request. Further, the scheduled media transmission object may also include an identification of whether the guest requested a media transmission that can be paused or snoozed, and an identification of whether a third party should receive a notification of a terminated scheduled media transmission.

At block 308, headend controller 230 may activate a guest's set top box 150 at or slightly before the guest's requested time. If the display(s) associated with the set top box 150 is no turned on, then at block 308 the headend controller and/or the set top box may power up the associated display(s). As part of the activation, headend controller 230 may transmit a message to the set top box 150 to initiate a scheduled media transmission session. The message may include an identification of the content to be transmitted. In one embodiment, headend controller 230 may also transmit an instruction to the set top box 150 to activate a display coupled to set top box 150, if set top box 150 is not integrated with a display device.

At block 310, a determination is made as to whether the guest's requested content is stored in a cache. If the content is stored in cache, method 300 proceeds to block 312. If not, method 300 proceeds to block 314, where the content is retrieved from, for example, a content store.

At block 312, the content is transmitted to the guest's set top box 150. In one embodiment, the content may be transmitted from an edge QAM as described above. In one embodiment, the content may be transmitted from a content delivery network.

At decision block 316, a determination is made as to whether a pause signal has been received. For example, the guest may use a button on a television remote, or select an option displayed on a display coupled to the set top box 150, to allow the guest to pause the scheduled media transmission, similar to a “snooze” feature of an alarm clock. If a pause signal is received, method 300 proceeds to block 318, where the media transmission is paused for a user-desired duration. In one embodiment, the user may be able to select the pause duration, such as 5 minutes, 10 minutes, or any other period of time. After the pause duration, method 300 proceeds to block 320, where the content is resumed. Method 300 then returns to decision block 316. If a pause signal is not received, method 300 proceeds to decision block 322.

At decision block 322, a determination is made as to whether a terminate signal is received. For example, the guest may use a button on a television remote, or select an option displayed on a display coupled to the set top box 150, to terminate the scheduled media transmission. Alternatively, the guest may use the button or select the option to acknowledge receipt of the scheduled media transmission. The terminate signal may be received, for example, by headend controller 230.

If the terminate signal is received, method 300 proceeds to block 324, where the scheduled media transmission is terminated. Method 300 then may proceed to block 326, where a message acknowledging the termination of the scheduled media transmission is transmitted, for example, to a third party. In one embodiment, the message may be transmitted to a hotel representative, to ensure that the guest has woken up at the guest's desired time. If such a message is not received, the hotel representative may elect to call the guest to ensure that the guest wakes up.

If a terminate signal is not received at decision block 322, method 300 may proceed to decision block 328, where a determination is made as to whether repeated media transmissions are enabled. If the guest has requested repeated media transmissions, method 300 proceeds to block 330, where the media content is repeated for as many times as requested by the guest. If the guest has not requested repeated media transmissions, method 300 proceeds to block 332, where the content terminates.

As described above, the guest's requested content item may include a video item. In one embodiment, the content item may also be a music or other audio file, a video (e.g., a music video, television program, or movie), a particular television channel (e.g. a sports channel, business channel, etc.), a default video message from the hotel, or any other content item that may be output by a set top box 150.

In one embodiment, the guest's request for the scheduled media transmission may include a volume level for the content item. In a further embodiment, the guest may request that the volume level for the content item gradually increase from zero to a requested or predetermined volume level, or from zero to a maximum volume level. Such a gradual increase may be more pleasing to the guest. In one embodiment, the guest may also request that the brightness or luminosity of a display 160 coupled to a set top box 150 be gradually increased.

In one embodiment, the guest's requested content item may repeat after the content item terminates. In one embodiment, the guest may press a button on a remote control or other device to cause the content item to terminate. In such an embodiment, the guest's use of the remote control may send a signal from the set top box 150 to the scheduling terminal 130 (or other hotel system) as an acknowledgement that the guest has woken up. The signal may be sent from set top box 150 to headend controller 230, which may transmit the message to scheduling terminal 130. In one embodiment, if no signal is received from the guest's set top box, a phone call or other communication may take place, to ensure that the guest has woken up.

In one embodiment, the set top box 150 may be integrated with a display device. In a further embodiment, the set top box 150 may be separate from a display device. In such an embodiment, set top box 150 may be configured to activate or turn on the display device, as part of the communication with headend controller 230 at or slightly before the scheduled time.

In one embodiment, upon scheduling the guest's request, scheduling terminal 130 may communicate with headend controller 230 to test the guest's set top box 150. For example, headend controller 230 may initiate a communication session with a set top box 150, and request an acknowledgment from set top box 150. Headend controller 230 may transmit a message to scheduling terminal 130 indicating that the guest's set top box 150 is in working order. A hotel representative may then confirm the scheduled video transmission for the requesting guest.

Although scheduling terminal 130 may be a convenient way to schedule a media transmission, the scheduling functionality of scheduling terminal 130 may also be incorporated into other devices. For example, computer-executable code may be added to a mobile application associated with the hotel or other hospitality institution, and the guest may be able to schedule his or her own media transmissions for his or her own room. Allowing the guest to schedule media transmissions in this way may reduce the need for additional hotel staff, and may allow the user to more conveniently schedule media transmissions.

Similarly, in one embodiment, scheduling terminal 130 may accept input using an interactive voice response (IVR) system. For example, a guest may use his or her guest room telephone to interact with a scheduling terminal 130 to request a scheduled media transmission. The IVR system may instruct the guest to input the guest's room number, desired content item, and requested time of the scheduled media transmission via voice or telephone keypad. Thus, the scheduling may be automated, and a hotel representative may not be needed.

Further, the guest's set top box 150 may provide an interactive application by which the guest can request a scheduled media transmission. The interactive application may accept input from the remote control for the set top box 150, and allow the guest to input the room number, desired content item, and requested time of the scheduled media transmission.

In one embodiment, the guest may specify a set top box or display device for the scheduled media transmission. For example, certain hotel rooms (for example, suites) have multiple television devices. The guest may specify that only the bedroom television should receive the scheduled media transmission at the requested time, or may specify that all television devices should receive the scheduled media transmission.

Although described with reference to a hotel or other hospitality institution, embodiments described herein are equally applicable to the residential area. For example, a parent or guardian of a child may use a scheduling application executed by a mobile device or tablet device to schedule a video transmission for a set top box in the child's room. In one embodiment, a user may schedule a media transmission for multiple set top boxes in a residence, for example, in each child's room. Further, the user may be able to confirm that each child has woken up by receiving messages confirming the termination of each scheduled media transmission, as described herein. Yet further, in an embodiment, a parent may schedule the activation of a video camera in a child's room for visual confirmation the child is in bed and asleep. Similarly, a video camera in a child's room can be scheduled to turn on and record the child waking up, such as in response to the play of certain wake-content.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for managing media transmissions, comprising:
receiving, by at least one processor, a request for a scheduled media transmission, wherein the request includes a desired time for the scheduled media transmission and a requested content item;
scheduling, by the at least one processor and for a user, the scheduled media transmission for the desired time;
activating, by the at least one processor, a media device associated with the user at the desired time; and
transmitting, by the at least one processor, the requested content item to the media device associated with the user.

2. The method of claim 1, further comprising:
determining, by the at least one processor, that the media device associated with the user can successfully receive the scheduled media transmission.

3. The method of claim 1, further comprising:
determining, by the at least one processor, that the requested content item is not stored in a cache; and
retrieving, by the at least one processor and from a content store, the requested content item.

4. The method of claim 1, wherein transmitting the requested content item to the media device associated with the user further comprises transmitting a uniform resource locator (URL) to the media device associated with the user.

5. The method of claim 1, further comprising:
receiving, by the at least one processor and from the media device associated with the user, a signal to terminate transmission of the requested content item; and
terminating, by the at least one processor, transmission of the requested content item.

6. The method of claim 5, further comprising:
transmitting, by the at least one processor and to a third party, a message indicating termination of the transmission of the requested content item.

7. The method of claim 1, further comprising:
receiving, by the at least one processor and from the media device associated with the user, a request to pause transmission of the requested content item for a specified duration of time; and
resuming, by the at least one processor, transmission of the requested content item after the specified duration of time has elapsed.

8. The method of claim 1, wherein activating a media device associated with the user at the desired time further comprises activating a display device coupled to the media device associated with the user.

9. A system for managing media transmissions, comprising:
at least one memory that stores computer-executable instructions; and
at least one processor configured to access the at least one memory, wherein the at least one processor is configured to execute the computer-executable instructions to:
receive a request for a scheduled media transmission, wherein the request includes a desired time for the scheduled media transmission and a requested content item;
schedule, for a user, the scheduled media transmission for the desired time;
activate a media device associated with the user at the desired time; and
transmit the requested content item to the media device associated with the user.

10. The system of claim 9, the at least one processor further configured to execute the computer-executable instructions to determine that the media device associated with the user can successfully receive the scheduled media transmission.

11. The system of claim 9, the at least one processor further configured to execute the computer-executable instructions to:
determine that the requested content item is not stored in a cache; and
retrieve, from a content store, the requested content item.

12. The system of claim 9, wherein transmitting the requested content item to the media device associated with the user further comprises transmitting a uniform resource locator (URL) to the media device associated with the user.

13. The system of claim 9, the at least one processor further configured to execute the computer-executable instructions to:
receive, from the media device associated with the user, a signal to terminate transmission of the requested content item; and
terminate transmission of the requested content item.

14. The system of claim 13, the at least one processor further configured to execute the computer-executable instructions to transmit, to a third party, a message indicating termination of the transmission of the requested content item.

15. The system of claim 9, the at least one processor further configured to execute the computer-executable instructions to:
receive, from the media device associated with the user, a request to pause transmission of the requested content item for a specified duration of time; and
resume transmission of the requested content item after the specified duration of time has elapsed.

16. A computer program product comprising a computer-readable medium having computer-executable instructions embodied therein, the computer-executable instructions when executed by at least one processor perform the operations comprising:
receiving a request for a scheduled media transmission, wherein the request includes a desired time for the scheduled media transmission and a requested content item;
scheduling, for a user, the scheduled media transmission for the desired time;
activating a media device associated with the user at the desired time; and
transmitting the requested content item to the media device associated with the user.

17. The computer program product of claim 16, the computer-executable instructions when executed by the at least one processor further perform the operations comprising:
determining that the media device associated with the user can successfully receive the scheduled media transmission.

18. The computer program product of claim 16, the computer-executable instructions when executed by the at least one processor further perform the operations comprising:
determining that the requested content item is not stored in a cache; and
retrieving, from a content store, the requested content item.

19. The computer program product of claim 16, wherein transmitting the requested content item to the media device associated with the user further comprises transmitting a uniform resource locator (URL) to the media device associated with the user.

20. The computer program product of claim 16, the computer-executable instructions when executed by the at least one processor further perform the operations comprising:
receiving, from the media device associated with the user, a signal to terminate transmission of the requested content item; and
terminating transmission of the requested content item.

21. The computer program product of claim 20, the computer-executable instructions when executed by the at least one processor further perform the operations comprising transmitting, to a third party, a message indicating termination of the transmission of the requested content item.
